(19) United States
(12) Patent Application Publication
(10) Pub. No.: US 2007/0002696 A1
(43) Pub. Date: Jan. 4, 2007

(54) RECORDABLE DVD STRUCTURE

(75) Inventor: Joseph J. Wrobel, Rochester, NY (US)

Correspondence Address: PATENT LEGAL STAFF, EASTMAN KODAK COMPANY, 343 STATE STREET, ROCHESTER, NY, 14650-2201, US

(73) Assignee: Eastman Kodak Company

(21) Appl. No.: 11/382,488

(22) Filed: May 10, 2006

Related U.S. Application Data
(63) Continuation-in-part of application No. 11/173,699, filed on Jul. 1, 2005.

(51) Int. Cl. G11B 21/08

(52) U.S. Cl. 369/30.07

(57) ABSTRACT

A structure of a recordable DVD disc is disclosed that will allow a second recording event to be recorded and accessed by DVD players that do not recognize multisession media by modifying the Extent Location in the Extent Descriptor of the Main Volume Descriptor Sequence Extent field in the Anchor Volume Descriptor Pointer of the first track or session to refer to an extent outside the first track or session.

### CROSS REFERENCE TO RELATED APPLICATIONS

This application is a continuation-in-part of U.S. patent application Ser. No. 11/173,699 filed Jul. 1, 2005, entitled “Recordable DVD Structure” by Joseph J. Wrobel. Reference is made to commonly assigned U.S. patent application Ser. No. 11/229,269 filed Sep. 16, 2005, entitled “Recordable DVD Structure” by Joseph J. Wrobel and U.S. patent application Ser. No. 11/229,275 filed Sep. 16, 2005, entitled “Recordable DVD Structure” by Joseph J. Wrobel, the disclosures of which are incorporated herein by reference.

### FIELD OF THE INVENTION

The present invention relates to optical recording discs and, more particularly, to an improved recordable Digital Versatile Disc (DVD) format disc structure.

### BACKGROUND OF THE INVENTION

Recordable DVD format discs are well known in the art. Physical standards for the DVD-R type recordable DVD format disc are available from the DVD Format/Logo Licensing Corporation. Physical standards for the DVD+R type recordable DVD format disc are available from the Intellectual Property & Standards group of the Philips Corporation.

In addition there are logical standards for the arrangement of data on the discs. The file structure on DVD media is typically compliant with the Universal Data Format (UDF) Specification defined and maintained by the Optical Storage Technology Association (OSTA). The UDF specification is a specific embodiment of the ECMA-167 standard entitled “Volume and File Structure for Write-Once and Rewritable Media using Non-Sequential Recording for Information Interchange”. All DVD-Video discs are mastered to contain all required data as specified by ECMA-167 (2^{nd} edition) and UDF 1.02.

In practice, most DVD media also incorporate the file structure specified by the International Standards Organization (ISO) 9660 standard (“Information processing—Volume and file structure of CD-ROM for information interchange”). If a disc contains both UDF and ISO 9660 file systems, then it is known as a UDF Bridge disc. According to the UDF version 2.50 document, consumer DVD players shall only support UDF and not ISO 9660. However, the presence of the ISO 9660 file structure on a DVD disc does not degrade its playability in a consumer DVD player.

The UDF standard applies to both forms of DVD media, ROM and recordable. The most recent version supports multisession recording. Multisession recording is important for write-once media such as DVD-R and DVD+R because it allows a user to add additional information to the disc over time. If a new recording event is done in accordance with the appropriate specifications, then a multisession capable player will be able to read all information recorded to the disc in all of the sessions.

Multisession recording is beneficial because given the substantial capacity of the DVD format, it is often the case that a disc is written well short of its capacity, and a user would benefit by adding more information at a later time. Multisession recording also finds use in applications in which a first session is recorded with generic content, for example software, and a second session is added with user specific data. An example of such a disc would be in an imaging application in which the first session contained image display software and the second session contained images belonging to the end user. The recordable DVD disc bearing the first session software could be sold to the public who could then add their images in a second session to be viewed using the software in the first session.

A multisession disc is closed to further append when a new session is written to the disc with the stipulation that it be the last session. This last session could contain new content or it could be a “dummy” session, i.e. session with no new content. In any case, the disc is finalized, i.e. put in a condition that allows no further additional sessions.

Unfortunately, although there are benefits to multisession DVD discs, the majority of the installed base of consumer DVD players are not multisession capable. They are produced to meet version 1.02 of the UDF specification that was issued before the process for multisession recording was defined in that specification. If a multisession disc is placed into a player that is not multisession capable, the player will only allow access to information stored in the first track of the first session; any subsequent information added to the disc is unknown to the player and will be inaccessible to the user.

When a disc is mounted in a DVD player, the player first establishes that the disc is recorded in accordance with the UDF specification. It does this by reading a series of sectors from the disc from the region defined by the UDF specification as the volume recognition area. If the disc complies with the UDF specification, the player will find a series of volume structure descriptors in a volume recognition sequence that is unique to a UDF compliant disc.

Once a disc is established as UDF compliant, the player then reads a data sector at one of the anchor points defined in the UDF specification. This sector will contain the Anchor Volume Descriptor Pointer. Within the Anchor Volume Descriptor Pointer, the player will find the extents of the Main and Reserve Volume Descriptor Sequences recorded on the disc. The Volume Descriptor Sequence contains all the information needed for the drive to access the information recorded on the disc including file and directory names, locations and sizes.

For a multisession disc, a new Anchor Volume Descriptor Pointer is written at the anchor points within each newly recorded session. The extents stored within the Anchor Volume Descriptor Pointer direct the player to the new Main and Reserve Volume Descriptor Sequences written within each newly recorded session. A player that is multisession compatible will recognize the presence of additional sessions and use the Anchor Volume Descriptor Pointer in the last recorded session to access the most recent Main and Reserve Volume Descriptor Sequences. This enables the drive to access all the information on the disc. A player that is not multisession compatible will not recognize the presence of additional sessions and use the Anchor Volume Descriptor Pointer in the first recorded session to access the original Main and Reserve Volume Descriptor Sequences. This will limit the drive to access only the information in the first track of the first session on the disc.

The inability of a large portion of the installed base of DVD players to recognize and correctly access all the information on a DVD disc recorded in multiple recording events limits the utility of applications that rely on this manner of recording.

### SUMMARY OF THE INVENTION

It is therefore an object of the present invention to provide a structure of a recordable DVD disc that will allow a second recording event to be recorded and accessed by players that do not recognize multisession media.

It is a further object of the present invention to provide a recordable DVD disc structure that is particularly beneficial for applications in which the first recording event is generic for many users and the second recording event is customized to an individual user.

This object is achieved by a recordable DVD disc, comprising:

a) a recorded first track or session; and

b) a value for the Extent Location in the Extent Descriptor of the Main Volume Descriptor Sequence Extent field in the Anchor Volume Descriptor Pointer in the first track or session that refers to an extent outside the first track or session.

The UDF specification for multisession recordable DVD discs defines a structure that limits access of a player that is not multisession capable to the first track of the first session on the disc. The present invention provides a structure that enables a player that is not multisession capable to access all the information recorded on a recordable DVD disc in two separate recording events.

### BRIEF DESCRIPTION OF THE DRAWINGS

FIG. 1 is a diagram of a DVD recordable disc bearing a first session;

FIG. 2 is a diagram of a DVD recordable disc bearing a first session and a second session;

FIG. 3 is a flow chart of a segment of a DVD player's operation;

FIG. 4 is a depiction of the use of the Main Volume Descriptor Sequence Extent in a standard recordable DVD disc structure; and

FIG. 5 is a depiction of the use of the Main Volume Descriptor Sequence Extent in a recordable DVD disc structure in accordance with the present invention.

### DETAILED DESCRIPTION OF THE INVENTION

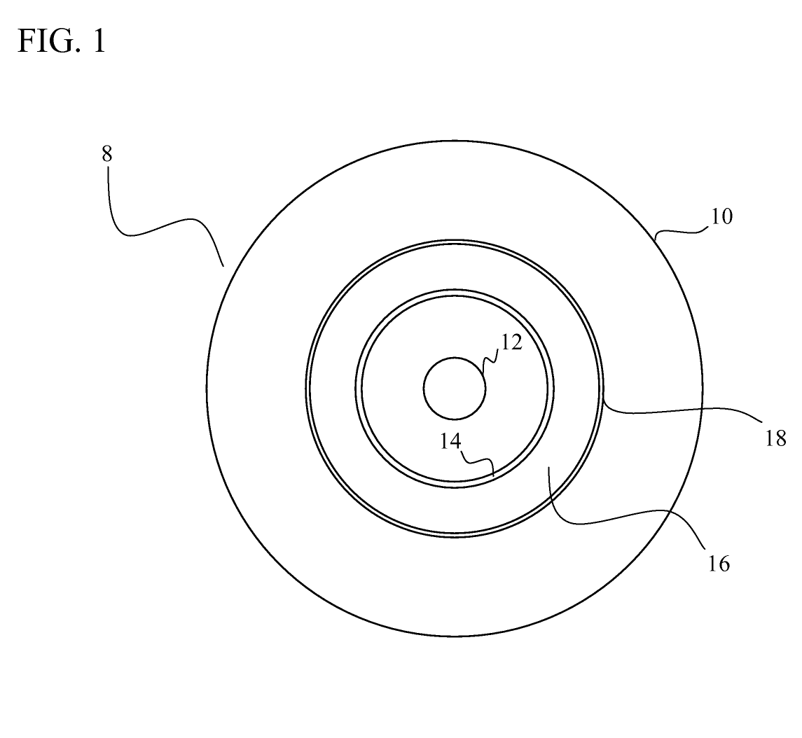

A recordable DVD disc 8 holds data in a physical area called a session. Each session is comprised of three zones: a lead-in zone, a data zone and a lead-out zone. The data zone consists of one or more recorded tracks. The disc 8 with a single recorded session is represented graphically in FIG. 1. Between the disc outer diameter 10 and the disc center hole 12, the disc 8 bears a single recorded session. A lead-in zone 14 of the first session is recorded at an inner diameter defined by the recordable DVD specification. Immediately following this lead-in zone 14 is a data zone 16 of the first session. The size of the data zone 16 is directly related to the amount of data stored in the first session. Immediately following this data zone 16 is a lead-out zone 18 of the first session.

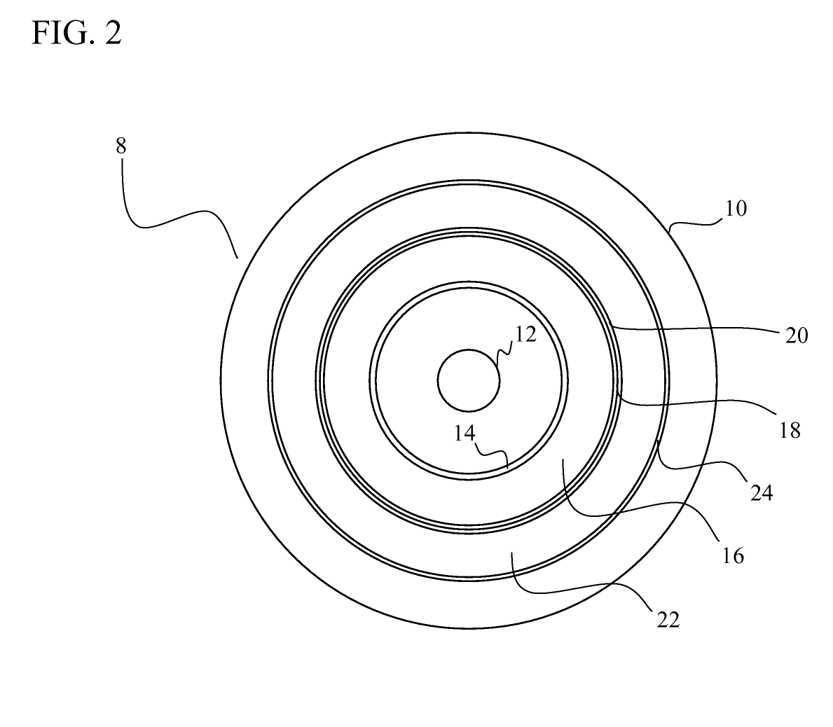

A recordable DVD 8 disc with a first recorded session and a second recorded session is represented graphically in FIG. 2. In addition to the features of a single session disc 8 shown in FIG. 1, a disc 8 with two sessions has three additional zones. A lead-in zone of the second session 20 is recorded immediately following the lead-out zone of the first session 18. Immediately following the lead-in zone of the second session 20 is a data zone 22 of the second session. The size of the data zone 22 is directly related to the amount of data stored in the second session. Immediately following this data zone 22 is a lead-out zone 24 of the second session.

The information as to whether a recorded DVD disc is single session or multisession is stored outside the data zones of the disc 8 as is well known in the disc making art. If a DVD player is multisession capable, it must read the session information before it begins to read the user data from the disc 8. The session information includes the location and length of each session on the disc 8. The DVD player needs this session information because as each new session is recorded, the structure that contains the current file and directory information is updated and recorded anew in the new session. The structure that contains file and directory information for the current content of the disc 8 is stored in the last recorded session. Once the number and location of the last session is known, the player accesses that session and begins to read information from the user data area of the session.

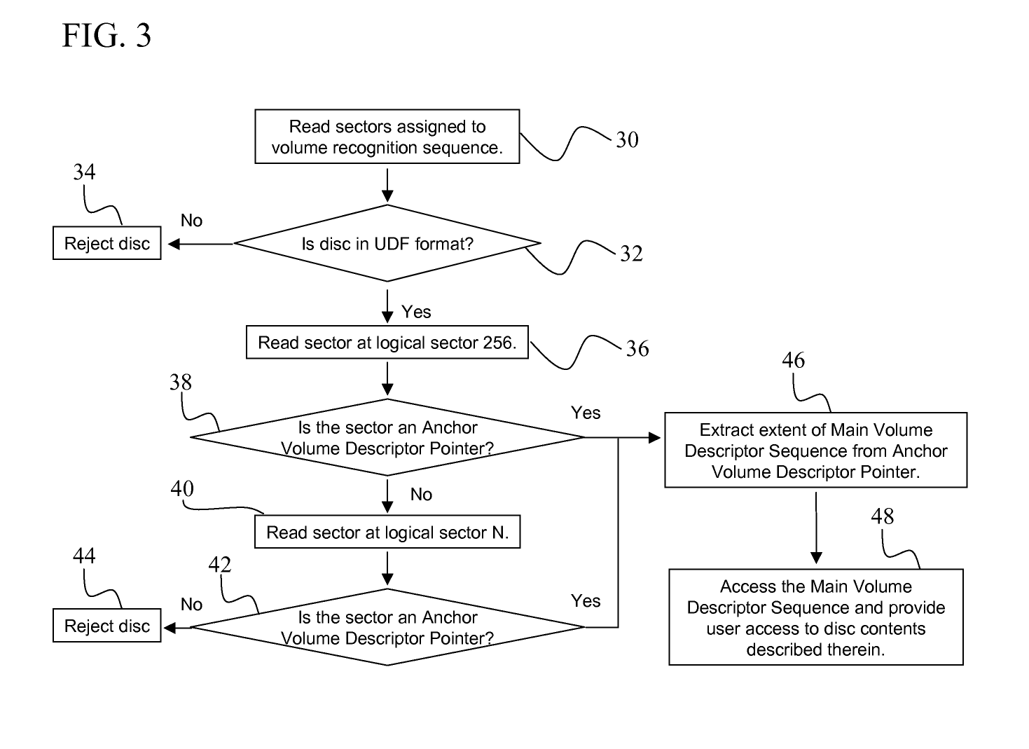

Referring to FIG. 3, a flow chart of a segment of a DVD player's operation is shown. This segment of the operation occurs after the DVD player recognizes a new disc 8 (FIG. 1) has been mounted and the necessary physical operations to provide focus and tracking have taken place, the session information has been read, and the last recorded session on the disc 8 has been accessed. In this segment the DVD player begins to determine the nature of the disc 8 in the DVD player and whether it is properly structured. The first operation (decision block 32) of the segment is to determine if the disc 8 is recorded in accordance with the UDF specification. In order to make this determination, the player reads an area (process block 30) of the disc 8 that must contain very specific information. In particular, the disc 8 must have a sequence of data sectors of pre-defined content recorded sequentially in a specific location on the disc 8. This sequence includes the UDF volume recognition sequence. If the volume recognition sequence is not found, the disc 8 is rejected (process block 34) as being non-compliant with the UDF specification.

If the volume recognition sequence is found, then the drive continues with the next operation in the segment. This next operation has the purpose of locating the Main Volume Descriptor Sequence. The Main Volume Descriptor Sequence contains these key descriptors for the disc 8: the Primary Volume Descriptor, the Implementation Use Volume Descriptor, the Partition Descriptor, the Logical Volume Descriptor, the Unallocated Space Descriptor and the Terminating Descriptor. Within these descriptors is the information needed by the player to access the directories and content data files stored on the disc 8. In order to access the Main Volume Descriptor Sequence, the player must first determine its location on the disc 8. The value of the extent of the Main Volume Descriptor Sequence is found within the Anchor Volume Descriptor Pointer. According to the UDF specification, the Anchor Volume Descriptor Pointer shall be recorded in at least two of the following three locations on the media:
Logical sector 256.
Logical sector (N-256).
Logical sector N
   where N is the largest logical sector number in the volume space. The drive now attempts to locate the Anchor Volume Descriptor Pointer. The order in which it interrogates the possible location is arbitrary, however version 1.02 of the UDF specification directs the player to logical sector 256, so FIG. 3 assumes the DVD player tries that location first. The drive performs a read operation (process block 36) at logical sector 256. It then makes a decision (decision block 38) based on the contents of sector 256 as to whether the sector contains the Anchor Volume Descriptor Pointer. If the Anchor Volume Descriptor Pointer is not in logical sector 256, the DVD player then searches one of the other possible locations. FIG. 3 assumes the player tries logical sector N next. The drive performs a read operation (process block 40) at logical sector N. It then makes a decision (decision block 42) based on the contents of sector N as to whether the sector contains the Anchor Volume Descriptor Pointer. If the Anchor Volume Descriptor Pointer is not found in the second location, the disc 8 is rejected (process block 44) since it does not comply with the UDF specification.

If the DVD player does locate an Anchor Volume Descriptor Pointer, it then performs the extraction (process block 46) of the extent of Main Volume Descriptor Sequence. This allows the DVD player to access (process block 48) the Main Volume Descriptor Sequence within the session.

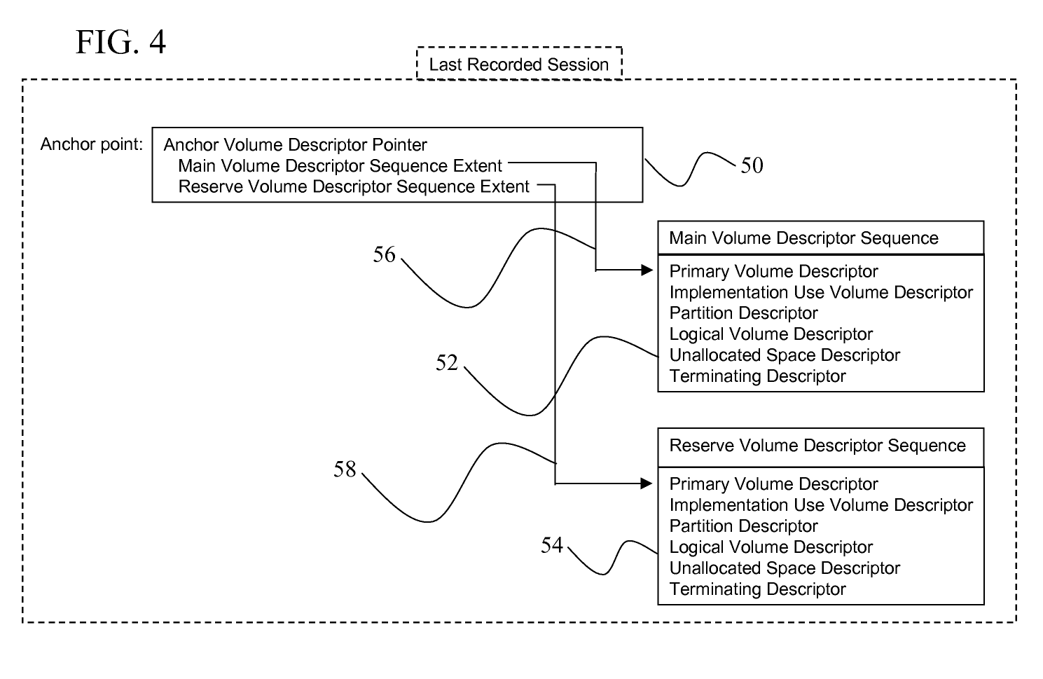

Referring to FIG. 4, a more detailed chart is provided of the Anchor Volume Descriptor Pointer 50, the Main Volume Descriptor Sequence 52, and the Reserve Volume Descriptor Sequence 54 in the last recorded session. As FIG. 4 indicates, the contents of the Main Volume Descriptor Sequence 52 and the Reserve Volume Descriptor Sequence 54 are identical. In the typical mode of operation, a DVD player will extract the Main Volume Descriptor Sequence Extent from the Anchor Volume Descriptor Pointer 50, access that extent 56, and utilize the contents of the Main Volume Descriptor Sequence 52 to provide access to the user content on the disc. As FIG. 4 illustrates, there is an alternative path to a structure that provides access to the disc contents. In the alternative mode of operation, a DVD player will extract the Reserve Volume Descriptor Sequence Extent from the Anchor Volume Descriptor Pointer 50, access that extent 58, and utilize the contents of the Main Volume Descriptor Sequence 52 to provide access to the user content on the disc 8 (FIG. 1).

If a DVD player is not multisession compatible and is dealing with a single session disc, then the process described above is carried out in the first track of the first (and only) session, and all the structure needed to access the user data and directories on the disc will be correctly read. If a DVD player is not multisession compatible and is dealing with a multisession disc, then the process described above is still carried out in the first track of the first session, and the structure found will only allow access to the user data and directories recorded in the first recording event which are found in the first track of the first session. Any user content subsequently recorded is inaccessible.

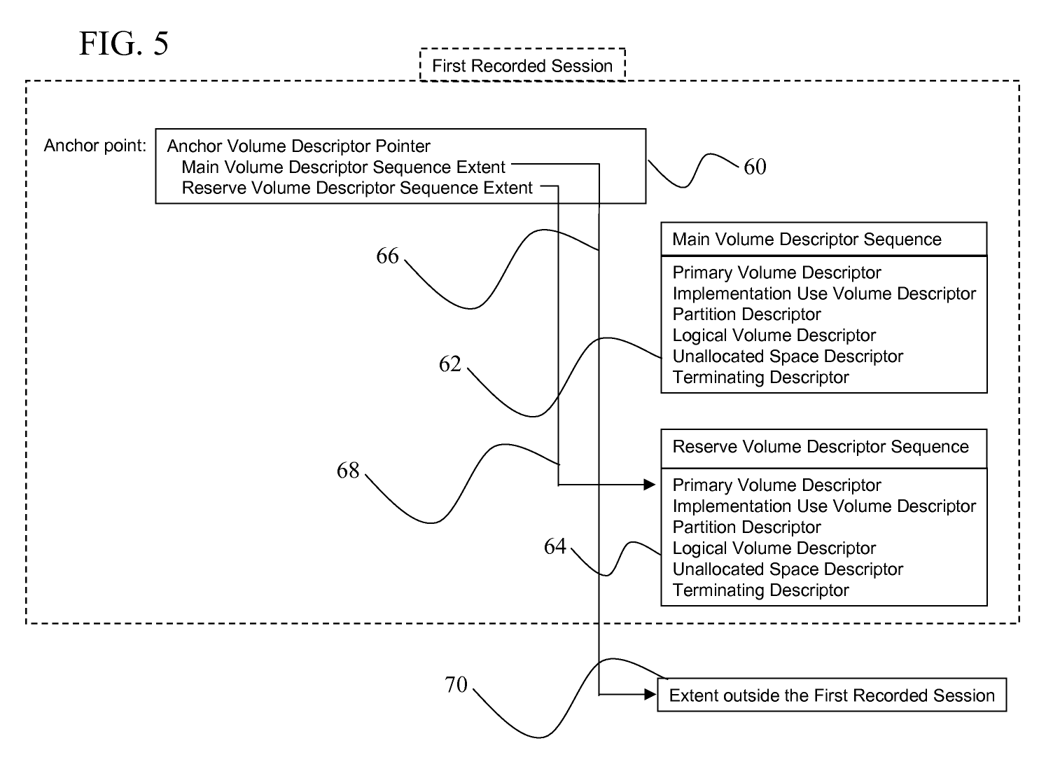

In order to allow all the data on a disc recorded in two recording events to be available to a DVD player that is not compatible with a multisession disc, the present invention enables the player to access the last structure recorded on the disc. Referring to FIG. 5, a detailed chart is provided of the Anchor Volume Descriptor Pointer 60, the Main Volume Descriptor Sequence 62, and the Reserve Volume Descriptor Sequence 64 in the first track of the first recorded session of a disc 8 made in accordance with the present invention. By altering the value of the Main Volume Descriptor Sequence Extent in an Anchor Volume Descriptor Pointer 60 in the first track of the first session to refer to an extent outside the first track of the first session, a DVD player that is not compatible with a multisession disc will be led to access a structure recorded after the first recording event.

Let us consider the case of a DVD player that is not multisession compatible dealing with a disc recorded in two recording events that has had the value for the Extent Location in the Extent Descriptor of the Main Volume Descriptor Sequence Extent field in the Anchor Volume Descriptor Pointer in the first session modified so that it refers to an extent outside the first track of the first session in accordance with the present invention.

Referring to FIG. 3, a flow chart of a segment of a DVD player's operation is shown. This segment of the operation occurs after the player recognizes a new disc 8 (FIG. 1) has been mounted and the necessary physical operations to provide focus and tracking have taken place, the session information has been read, and the last recorded session on the disc 8 has been accessed. In this segment the DVD player begins to determine the nature of the disc 8 in the DVD player and whether it is properly structured. The first operation in decision block 32 of the segment is to determine if the disc 8 is recorded in accordance with the UDF specification. In order to make this determination, the DVD player reads an area of the disc 8 (process block 30) that must contain very specific information. In particular, the disc 8 must have a sequence of data sectors of pre-defined content recorded sequentially in a specific location on the disc 8. This sequence includes the UDF volume recognition sequence. If the volume recognition sequence is not found, the disc 8 is rejected in (process block 34) as being non-compliant with the UDF specification.

If the volume recognition sequence is found, then the drive continues with the next operation in the segment. This next operation has the purpose of locating the Main Volume Descriptor Sequence 62. The Main Volume Descriptor Sequence 62 contains these key descriptors for the disc 8: the Primary Volume Descriptor, the Implementation Use Volume Descriptor, the Partition Descriptor, the Logical Volume Descriptor, the Unallocated Space Descriptor and the Terminating Descriptor. Within these descriptors is the information needed by the DVD player to access the directories and content data files stored on the disc In order to access the Main Volume Descriptor Sequence 62, the DVD player must first determine its location on the disc 8. The value of the extent of the Main Volume Descriptor Sequence 62 is found within the Anchor Volume Descriptor Pointer. According to the UDF specification, the Anchor Volume Descriptor Pointer shall be recorded in at least two of the following three locations on the media:
Logical sector 256.
Logical sector (N-256).
Logical sector N
   where N is the largest logical sector number in the volume space. The drive now attempts to locate the Anchor Volume Descriptor Pointer. The order in which it interrogates the possible location is arbitrary, however version 1.02 of the UDF specification directs the player to logical sector 256, so FIG. 3 assumes the DVD player tries that location first. The drive performs a read operation in process block 36 at logical sector 256. It then makes a decision in decision block 38 based on the contents of sector 256 as to whether the sector contains the Anchor Volume Descriptor Pointer. If the Anchor Volume Descriptor Pointer is not in logical sector 256, the DVD player then searches one of the other possible locations. FIG. 3 assumes the DVD player tries logical sector N next. The drive performs a read operation in process block 40 at logical sector N. It then makes a decision in decision block 42 based on the contents of sector N as to whether the sector contains the Anchor Volume Descriptor Pointer. If the Anchor Volume Descriptor Pointer is not found in the second location, the disc 8 is rejected in process block 44 since it does not comply with the UDF specification.

If the DVD player does locate an Anchor Volume Descriptor Pointer, it then performs the extraction in process block 46 of the extent of Main Volume Descriptor Sequence 62.

Recall that on the disc 8 the Anchor Volume Descriptor Pointer has been modified so that it refers to an extent outside the first track of the first session 70. The DVD player is expecting to find a Main Volume Descriptor Sequence at this extent. Therefore, for the DVD player to properly access the user content on the disc 8, it is necessary that at the extracted extent there exist a valid Main Volume Descriptor Sequence. Thus the modification of the extent of Main Volume Descriptor Sequence, which must take place before the first session is recorded in the case of a recordable DVD-R or DVD+R disc, must be chosen with foreknowledge of where the Main Volume Descriptor Sequence will be located in the last recorded session.

A general method for creating a recordable DVD disc recorded in two recording events that is compatible with players that do not recognize multisession DVD media is outlined below.

1) Prepare a binary image of a first track for recording on a recordable DVD disc including both binary data and a file system compatible with the Universal Disk Format Specification. (A binary image contains the actual data that should exist on the DVD disc.) Alternatively the first track can be recorded in standard fashion and subsequently the binary image generated by reading the first track from the disc as a binary image.

2) Based on the size of the binary image of the first track, compute what the starting sector of the next recording event would be. This value depends on the mode in which the disc will be written, i.e. track-at-once mode or session-at-once mode. Alternatively, a second recording can be recorded after the first recording in the desired mode, and the starting sector of the second recording read from the disc using appropriate software tools.

3) Modify the binary image of the first track of the first session by changing the Extent Location of the Main Volume Descriptor Sequence Extent found in the Anchor Volume Descriptor Pointer. The Extent Location is changed to one of two values. One option is to change the value of the Extent Location to specify the location of the Main Volume Descriptor Sequence in the second recording event; this value is typically 32+the computed or measured starting sector of the second recording event. The other option is to change the value of the Extent Location to specify the location of the Reserve Volume Descriptor Sequence in the second recording event; this value is typically 48+the computed or measured starting sector of the second recording event. Note that the starting sector of the second recording event is independent of the content of the second recording event. Thus the new value of the Extent Location is correct for any second recording event regardless of content.

4) Record the modified binary image of the first track of the first session in either track-at-once or session-at-once mode in accordance with the mode used in step 2).

5) Modify the authoring software responsible for creating the second recording event to use the Reserve Volume Descriptor Sequence Extent found in the Anchor Volume Descriptor Pointer of the first track in the first session to obtain information about the contents of the first recording event. Alternatively the authoring software may automatically default to the Reserve Volume Descriptor Sequence when it determines that the Main Volume Descriptor Sequence Extent refers to an extent outside the first recording event.

When the second recording event is completed, a DVD player that does not recognize multisession DVD media will use the Extent Location of Main Volume Descriptor Sequence Extent found in the Anchor Volume Descriptor Pointer of the first track of the first session to locate the Main Volume Descriptor Sequence. Due to the modification of the original first track binary image, this Extent Location will be the Extent Location of Main Volume Descriptor Sequence recorded in the second recording event. The DVD player will then access the UDF file structure in the second recording event and will be able to access binary data in both the first and second recording event.

The invention has been described in detail with particular reference to certain preferred embodiments thereof, but it will be understood that variations and modifications can be effected within the spirit and scope of the invention.

### PARTS LIST

8 disc

10 disc outer diameter

12 disc centering hole

14 first session lead-in zone

16 first session data zone

18 first session lead-out zone

20 second session lead-in zone

22 second session data 24 zone

24 second session lead-out zone

30 process block

32 decision block

34 process block

36 process block

38 decision block

40 process block

42 decision block

44 process block

46 process block

48 process block

50 Anchor Volume Descriptor Pointer in the last recorded session

52 Main Volume Descriptor Sequence in the last recorded session

54 Reserve Volume Descriptor Sequence in the last recorded session

56 access path to Main Volume Descriptor Sequence in the last recorded session

58 access path to Reserve Volume Descriptor Sequence in the last recorded session

60 Anchor Volume Descriptor Pointer in the first recorded session

Parts List Cont'd

62 Main Volume Descriptor Sequence in the first recorded session

64 Reserve Volume Descriptor Sequence in the first recorded session

66 access path to extent outside first recorded session

68 access path to Reserve Volume Descriptor Sequence in the first recorded session

70 extent outside first recorded session

1. A recordable DVD disc, comprising:
a) a recorded first session; and
b) an Anchor Volume Descriptor Pointer in the first session having a Main Volume Descriptor Sequence Extent field having an Extent Descriptor with an Extent Location having a value that refers to an extent location outside the first session.

2. The recordable DVD disc of claim 1 wherein the value for the Extent Location in the Extent Descriptor of the Main Volume Descriptor Sequence Extent field in the Anchor Volume Descriptor Pointer in the first session is the logical sector number of a Main Volume Descriptor Sequence to be recorded in a second or later session.

3. The recordable DVD disc of claim 1 wherein the value for the Extent Location in the Extent Descriptor of the Main Volume Descriptor Sequence Extent field in the Anchor Volume Descriptor Pointer in the first session is logical sector number 32 of a second or later session.

4. The recordable DVD disc of claim 1 wherein the value for the Extent Location in the Extent Descriptor of the Main Volume Descriptor Sequence Extent field in the Anchor Volume Descriptor Pointer in the first session is the logical sector number of a Reserve Volume Descriptor Sequence to be recorded in a second or later session.

5. The recordable DVD disc of claim 1 wherein the value for the Extent Location in the Extent Descriptor of the Main Volume Descriptor Sequence Extent field in the Anchor Volume Descriptor Pointer in the first session is logical sector number 48 of a second or later session.

6. A recordable DVD disc, comprising:
a) a recorded first track; and
b) an Anchor Volume Descriptor Pointer in the first track having a Main Volume Descriptor Sequence Extent field having an Extent Descriptor with an Extent Location having a value that refers to an extent location outside the first track.

7. The recordable DVD disc of claim 6 wherein the value for the Extent Location in the Extent Descriptor of the Main Volume Descriptor Sequence Extent field in the Anchor Volume Descriptor Pointer in the first track is the logical sector number of a Main Volume Descriptor Sequence to be recorded in a second or later track.

8. The recordable DVD disc of claim 6 wherein the value for the Extent Location in the Extent Descriptor of the Main Volume Descriptor Sequence Extent field in the Anchor Volume Descriptor Pointer in the first track is logical sector number 32 of a second or later track.

9. The recordable DVD disc of claim 6 wherein the value for the Extent Location in the Extent Descriptor of the Main Volume Descriptor Sequence Extent field in the Anchor Volume Descriptor Pointer in the first track is the logical sector number of a Reserve Volume Descriptor Sequence to be recorded in a second or later track.

10. The recordable DVD disc of claim 6 wherein the value for the Extent Location in the Extent Descriptor of the Main Volume Descriptor Sequence Extent field in the Anchor Volume Descriptor Pointer in the first track is logical sector number 48 of a second or later track.

11. The recordable DVD disc of claim 6 wherein the first track and the extent location outside the first track are in the same session.

12. The recordable DVD disc of claim 6 wherein the first track and the extent location outside the first track are in different sessions.
